(19) United States
(12) Patent Application Publication
(10) Pub. No.: US 2023/0376975 A1
(43) Pub. Date: Nov. 23, 2023

(54) CLOUD-BASED SYSTEM AND METHOD FOR DYNAMIC INCIDENT MANAGEMENT USING MACHINE LEARNING OPERATIONS

(71) Applicant: NCR Corporation, Atlanta, GA (US)

(72) Inventors: Kun Zhu, Smyrna, GA (US); Catherine Foster, Marietta, GA (US); James Bailey, Fernandina Beach, FL (US); Yung-Hang Chang, Marietta, GA (US)

(21) Appl. No.: 17/748,388

(22) Filed: May 19, 2022

(51) Int. Cl. G06Q 30/02

(52) U.S. Cl. CPC G06Q 30/0202

(57) ABSTRACT

A dynamic incident management system and method receives and stores business customer sales information. This information includes information about sales by day and time of day for a period of time at each business location. A machine learning model is generated for forecasting revenue for each business location based on the received information. A plurality of work orders are received for service calls to certain business customer sales locations. A priority is assigned to each of the received work orders. A rank is assigned to each of the received work orders having a common priority, based on, at least in part, a revenue forecast provided the machine learning module of sales at a projected day and time for the service call. Updated work orders having the priority and rank information are supplied to an incident management supplier for performing the associated service calls based on the priority and rank information.

### FIELD

This disclosure relates generally to a cloud-based system and method for dynamic incident management, and more particularly to a cloud-based system and method for dynamic incident management using machine learning operations.

### BACKGROUND

Many companies provide equipment that is used by various locations of a business during day to day operations. When problems arise with the equipment at a particular business location and the equipment becomes out of order and requires service, the operation of that location can be impacted, with the severity of the impact increasing based on the length of the outage. A company providing such equipment may also provide a service agreement to the business which commits to resolve work orders (incidents for help desk and service requests for field service) within a pre-defined time window based on a priority of the work order. A critical onboarding task for each work order is to define the priority of that work order based on business impact, location profile, equipment type, etc. Once a work order is created, it is typically assigned a static priority. A drawback is that a static priority does not factor in, for example, seasonality and the time-variant nature of revenue at a particular business location. For example, a coffee shop located close to an office building complex could tend to generate peak revenue around lunch time on workdays, while another coffee shop located close to a residential area may have its peak revenue in the morning, late afternoon, or evening on every day of the week.

Accordingly, there is a need for an improved incident management system which overcomes the drawbacks identified above.

### BRIEF DESCRIPTION OF THE DRAWINGS

The following detailed description, given by way of example and not intended to limit the present disclosure solely thereto, will best be understood in conjunction with the accompanying drawings in which:

FIG. 1A is a block diagram of a cloud-based system for dynamic incident management using machine learning operations according to the current disclosure, and FIG. 1B is a block diagram of a server for use in that cloud-based system;

FIG. 2 is a flowchart of first aspects of the cloud-based method for dynamic incident management using machine learning operations according to the current disclosure;

FIG. 3 is a flowchart of second aspects of the cloud-based method for dynamic incident management using machine learning operations according to the current disclosure;

FIG. 4 is a flowchart of third aspects of the cloud-based method for dynamic incident management using machine learning operations according to the current disclosure; and

FIG. 5 is a diagram of a web-based dashboard for tracking an effectiveness of the cloud-based method for dynamic incident management using machine learning operations according to the current disclosure.

### DETAILED DESCRIPTION

In the present disclosure, like reference numbers refer to like elements throughout the drawings, which illustrate various exemplary embodiments of the present disclosure.

The system and method of the present disclosure adjusts incident priorities based on an impact to the location of a business in order to maximize customer revenue protection based on fixed help desk and field capacity for service calls. The impact is calculated by a machine learning model which continually forecasts revenue based on past transaction data for that location. The system and method of the present disclosure optimizes the service call process by leveraging a fixed service capacity in a way which maximizes customer revenue protection. In particular, the system and method provides an adaptive approach in which work order priorities are adjusted on-the-fly based on the time-variant business location revenue based upon the business locations which are competing for resources from the same service region. This system and method optimizes the service process by focusing on business locations with the highest business impact by day and by hour, given that there is a fixed amount of resources for performing service calls. By doing this, the amount of lost revenue for customers due to service-impacting incidents is greatly minimized.

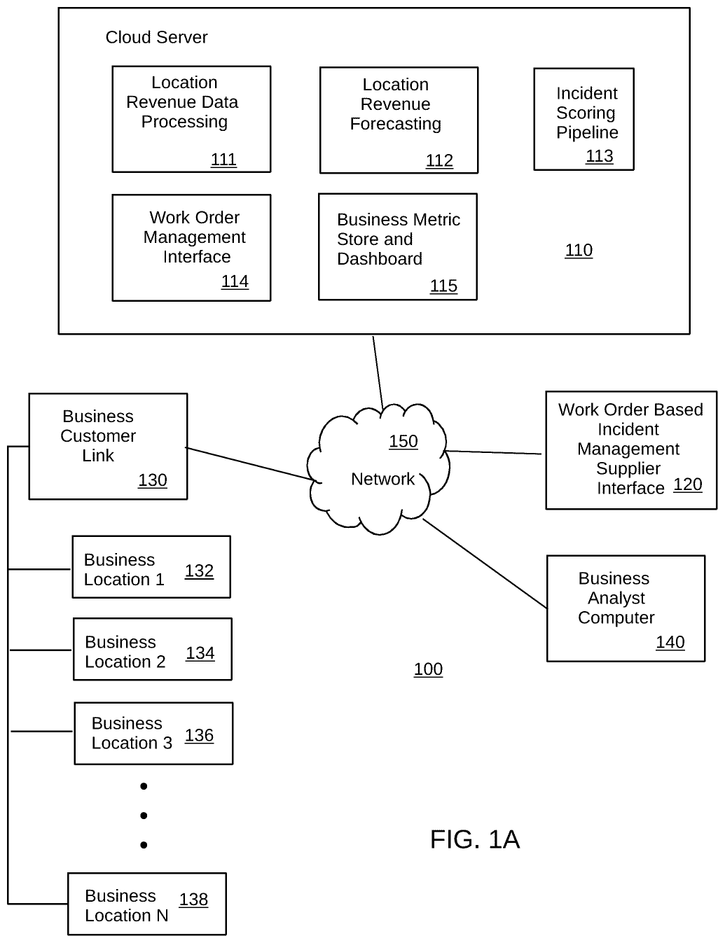

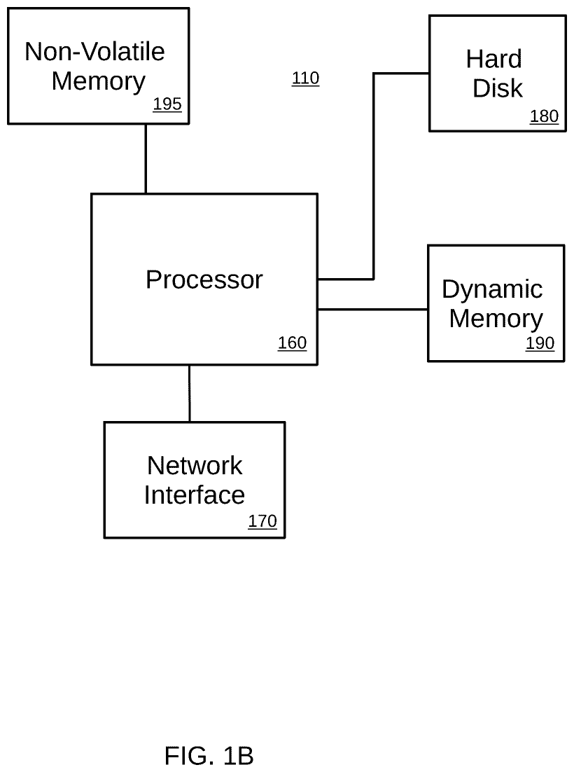

Referring now to FIG. 1A, the system 100 of the current disclosure includes a cloud server 110 that is coupled via a network 150 to a work order-based incident management supplier interface 120, a business customer link 130, and, optionally for monitoring purposes, a business analyst computer 140. The system 100 may be implemented in conjunction with any type of business which uses equipment from a supplier as part of its day-to-day operations at the various locations of that business. For example, a coffee shop business having multiple locations may use one or more point of sale (POS) terminals from a single supplier at each location, and that supplier or a third party may offer maintenance service contracts to the coffee shop business to ensure that any problems that arise with respect to the POS terminals are resolved quickly. System 100 can be used by the maintenance service supplier of or engaged by the supplier or third party to more efficiently manage service resources, as explained below.

The system and method presented herein can be implemented in whole or in part in one, all, or some combination of the components shown with the system 100. The method is programmed as executable instructions in memory and/or non-transitory computer-readable storage media and processed on one or more processors associated with the various components.

As shown in FIG. 1B, the cloud server 110 includes one or more central processing units (processors) 160, a network interface 170, at least one hard disk (HD) 180, volatile memory 190, and non-volatile memory 195. The non-volatile memory 195 includes a basic input/output system (BIOS) used to initiate a boot of the server 110. The HD 180 may be any type of non-volatile memory device (i.e., a non-transitory computer-readable storage medium) used to hold an operating system for a computer-based system and the term “hard disk” as used herein is intended to be broadly defined to include both electro-mechanical data storage devices and solid state drives. The HD 180 holds the programs (software applications) which load into volatile memory 190 upon boot of the operating system to provide the functionality discussed herein. It is to be noted that the components are shown schematically in greatly simplified form, with only those components relevant to understanding of the embodiments being illustrated. The various components (that are identified in the FIG. 1B) are illustrated and the arrangement of the components is presented for purposes of illustration only. It is to be noted that other arrangements with more or less components are possible without departing from the teachings of the system and method presented herein.

A work order-based incident management supplier processes customer requests for service and arranges for (or provides) service visits which are provided in an order based on prioritized and ranked work orders from the cloud server 110. The supplier interface 120 is the transfer portal used by the maintenance service supplier in order to exchange word orders for arranging prioritized/ranked service calls pursuant updated work orders provided by the system and method of the present disclosure.

The business customer link 130 accumulates and transfers to cloud server 110 business customer sales information from each business location in a particular service area, e.g., from business location 1 132, business location 2 134, business location 3 136, and up to business location N 136 (when there are N business locations within that particular service area). Each of the business locations has equipment from the supplier that is used as part of the business location revenue generation (e.g., POS terminals). The business customer link 130 may be a web application programming interface (API) such as a RESTful API. A RESTful API (also be referred to as a RESTful web service) is a web service API implemented using Hypertext Transfer Protocol (HTTP) and Representational state transfer (REST) technology.

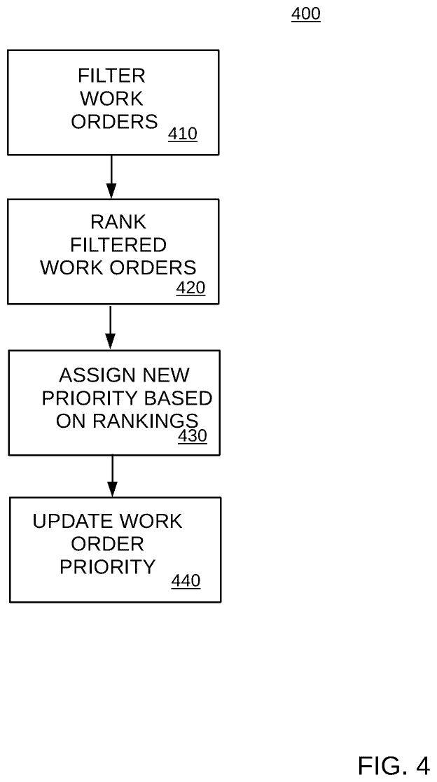

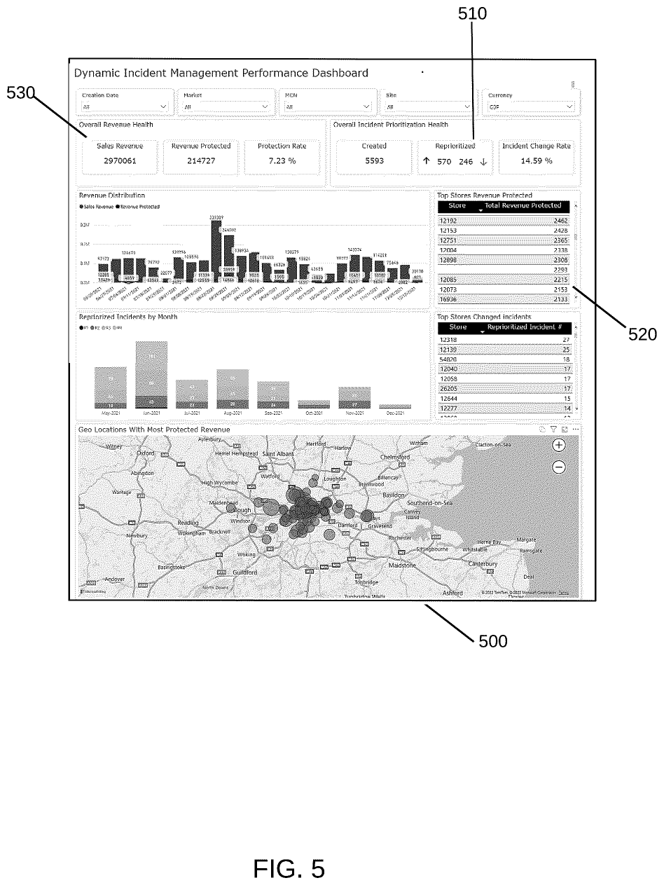

The business analyst computer 140 is for accessing the business dashboard 500 shown in FIG. 4 and discussed below. The network 150 maybe any type of network arrangement (public or private), but is preferably a public wide area network such as the Internet.

The cloud server 110 may be implemented as a Microsoft® Azure technology stack and has five primary functional blocks. The location revenue data processing block (module) 111 acquires the business customer sales information from the business customer link 130 (RESTful API) via network 150 and then formats and stores the acquired business customer sales information for further processing. The business customer sales data may include, for example, revenue by location by channel by hour in order to optimize the prioritization, ranking, and resolution of service-impacting incidents. The location revenue data processing block 111 is implemented as executable instructions programmed and residing within dynamic memory 190 and/or a non-transitory computer-readable (processor-readable) storage medium (hard disk 180) and executed by one or more processors 160.

The location revenue forecasting block (module) 112 processes the acquired business customer sales information to generate a location revenue forecast model (machine learning model). In an embodiment, the stored revenue forecast model may be a time-series forecast model developed in the Databricks platform using the open-source Prophet library which forecasts location revenue for a fixed future period of time (e.g., the next seven days) based on received location revenue data. Databricks is an open and unified platform for data engineering, data science, and data analytics. Because the location revenue forecast model is updated regularly based on the receipt of additional customer location data acquired via the business customer link, the implementation of system 100 is a full-blown machine learning Operation (MLOps) Pipeline, ensuring that the Machine Language model can accurately predict sales information for each business location by day and time of day, at least. The location revenue forecasting block 112 is implemented as executable instructions programmed and residing within dynamic memory 190 and/or a non-transitory computer-readable (processor-readable) storage medium (hard disk 180) and executed by one or more processors 160.

The incident scoring pipeline block (module) 113 includes heuristics for calculating the final priority and ranking for each work order. The heuristics for prioritization are triggered once an incident is created (e.g., when a work order is first generated). An initial priority is assigned based on equipment type and level of service required (e.g., how many POS terminals are not working, whether the equipment failure completely impacts revenue collection, etc.). Then a scoring script is run in which all pending work orders are compared. The business locations have a static ranking based on predicted income for each hour of the day, based on the machine language model. The scoring script applies weighted factors including overall business revenue, revenue per business day, peak revenue hours, and location. For example, the scoring script may apply a weight of 40% to revenue, 25% to business day, 25% to peak hours, and 10% to event venue (location) in order to re-prioritize each work order. Other factors, including available resources, may be used as part of the process. For incidents having the same priority score, rankings are may also be assigned to each ticket based on expected location revenue. The incident scoring pipeline block 113 is implemented as executable instructions programmed and residing within dynamic memory 190 and/or a non-transitory computer-readable (processor-readable) storage medium (hard disk 180) and executed by one or more processors 160.

The scoring script operation is shown in the flowchart 400 of FIG. 4. In a first step 410, work orders are filtered to remove those addressed to resolved and cancelled incidents and those addressed to incidents with a status of “rejected” or “fixed.” In addition, the filtering step 410 may also ensure that only those work orders for a certain customer (when handling work orders for multiple customers) are selected for ranking. Next, at step 420, a business impact score may be calculated for each customer stores based on one or more of the following factors store location (L), store busy hours (B), store predicted revenues for a fixed period of time (e.g., for the next four hours) (R), and customer-labeled store priority (i.e., a priority assigned by the customer) (P). The store location (L) is a predefined metric rating of the popularity of the geographic location of the store. For example, a store in a mall or a metropolitan area will have higher weight factor than a store in a less populous area. The store busy hours (B) is determined by historical revenue profile. For example, coffee shops usually have busy hours in the morning (e.g., from 8:00 am to 10:00 am and in the mid-afternoon (e.g., from 2:00 pm to 3:00 pm) in the afternoon. Some stores may have longer or different busy hours. The weight factor B assigned to the store depends on the incident creation time and the historical revenue profile. The customer-labeled store priority stores (P) is assigned by the customer and provides a higher weighting factor to the high priority stores. The business impact rank is a composite index that combines above mentioned weighted factor multiply the sum of predicted revenues (R) for a store in the next 4 hours. In one embodiment, the business impact rank for each work order can be calculated as BI=(L+B+P)*R. Each new work order is ranked upon receipt. Next, at step 430, an updated priority is assigned for the work orders for incoming incidents, taking the following consideration: service territory (incidents within the same service territory are reprioritized), and the availability of a customer engineer for each priority level. Finally, at step 440, the priority of the work orders is updated based on the operations of steps 420 and 430.

The work order management interface block (module) 114 allows information about pending work orders to be exchanged between cloud server 110 and the supplier interface 120. This information may include the original work order details supplied to cloud server 110 and updated work orders having new priority/ranking details which are supplied to supplier interface 120 for routing the service calls to the business locations. The updated priority/ranking information may be supplied together with justification for any changes. The work order management interface block 114 is implemented as executable instructions programmed and residing within dynamic memory 190 and/or a non-transitory computer-readable (processor-readable) storage medium (hard disk 180) and executed by one or more processors 160.

The business metric store and dashboard block (module) 115 stores all of the calculated business metrics based on updated priorities and rankings, and provides a web-based dashboard 500 shown in FIG. 4 for use by business analysts in order to review and evaluate the effectiveness of system 100. The key business metrics include: (1) the number and percentage of work orders (e.g., incidents or requested service calls) with priority changes 510; (2) protected revenue per business location per week 520 (calculated through back-casting using the store actual revenue and incident resolution time); (3) the accumulated protected revenue over a predetermined period 530; and, (4) incident resolution time duration changes. The information provided by dashboard 500 allows the business analysts (via computers 140) to ensure that the effectiveness of system 100. A predetermined period for accumulated protected revenue may be selected by the business customer, and may be, for example, by day, by month, by quarter, or by year. Other information that may be tracked includes incident resolution time duration changes (to allow the tracking of faster resolution for incidents re-prioritized to a higher priority than originally reported) and incident resolution times for incidents re-prioritized to a lower priority) to pinpoint resources reallocated to higher, more impacting, incidents). The business metric store and dashboard block 115 is implemented as executable instructions programmed and residing within dynamic memory 190 and/or a non-transitory computer-readable (processor-readable) storage medium (hard disk 180) and executed by one or more processors 160.

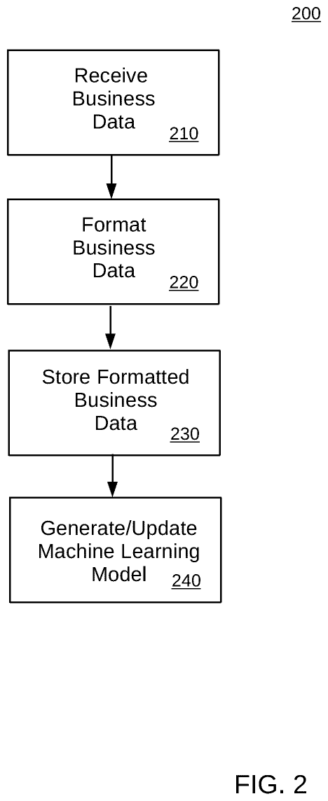

In operation, there are two parallel processes in operation, all of which are implemented as executable instructions programmed and residing within dynamic memory 190 and/or a non-transitory computer-readable (processor-readable) storage medium (hard disk 180) and executed by one or more processors 160. The first is shown in the flowchart 200 in FIG. 2 and relates to how the business customer sales information is received, stored, and processed to generate (or update) a machine learning model for forecasting business revenue for a desired future period of time. First, the business data is received at step 210 via, for example, the business customer link 130 and the location revenue processing block 111. Next, the business data is formatted, step 220, and stored in a data store (e.g., a server memory), step 230. The formatting and storing steps 220, 230 are performed by the location revenue processing block 111. Finally, at step 240, the machine learning model is generated and continually updated as new business customer data is received by the location revenue forecasting block 112. This ensures that the machine learning model is able to accurately predict sales information for each business location by least day and hour of the day. In this way, the machine learning model allows work order service calls to be routed to minimize revenue disruption, as discussed below.

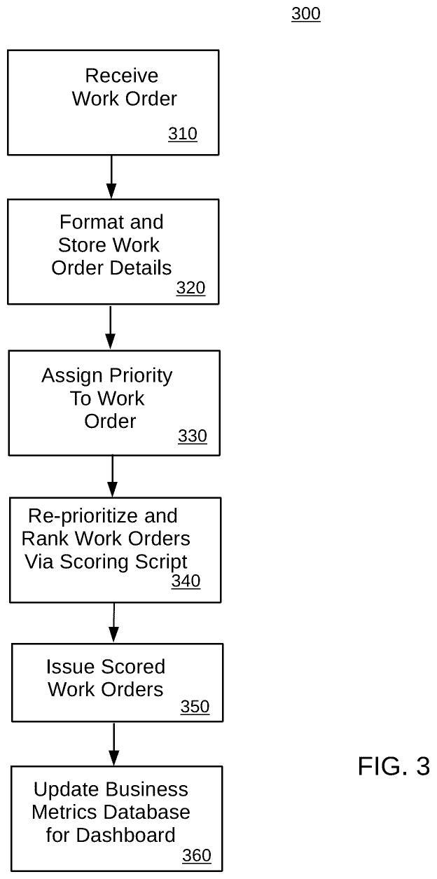

The second on-going process is shown in flowchart 300 of FIG. 3. Work orders are received at step 310 and information about each received work order is formatted and stored at step 320. Steps 310 and 320 are preferably performed by the work order management interface 114. Next, as discussed above, an initial priority is assigned to each work order at step 330 by the incident scoring pipeline module 113. As discussed above, the initial priority is assigned based on equipment type and level of service required. Alternatively, the initial priority may be assigned by the incident management (service) supplier. Next, a scoring script is run at step 340 by the incident scoring pipeline module 113 which re-prioritizes (if necessary) and ranks (if necessary) work orders, as discussed above. The scored work order (i.e., the re-prioritized and ranked work order) is issued to the service supplier at step 350 by the work order management interface block 114. For example, if two similar locations both needed a similar level of service (e.g., of the same priority), the machine learning model provides predicted revenue for each location for a particular service call window of time for comparison. So if the window of time for the service call is mid-morning and if one of the two locations has a higher predicted mid-day revenue than the other, that location will be ranked higher in order to minimize any disruption to the expected mid-day revenue. The service supplier will receive the scored work orders and arrange for service calls which are provided in an order based on the priority and rank information. Finally, the business metrics database is updated based on the changes made by the scoring script at step 360.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A method of providing dynamic incident management, comprising:
receiving and storing, by a location revenue processing module running on a processor, business customer sales information for each business customer sales location among a plurality of business customer sales locations, the business customer sales information including information about sales by day and time of day for a period of time at each business customer sales location;
generating, by a location revenue forecasting module running on a processor, a machine learning model for forecasting revenue for each business customer sales location based on the received business customer sales information;
receiving and storing, by a work order management module running on a processor, a plurality of work orders for service calls to certain ones of the plurality of business customer sales locations, each work order for a corresponding one of the business customer sales locations;
assigning, by an incident scoring pipeline module running on a processor, a priority to each of the received work orders;
assigning, by the incident scoring pipeline module, a rank to each of the received work orders having a common priority, the rank based on, at least in part, a revenue forecast provided the machine learning module of revenue at each corresponding business customer sales location at a projected day and time for the service call associated with the work orders; and
forwarding, by the work order management module, updated work orders having priority and rank information to an incident management supplier for arranging for the associated service calls to be performed in an order based on the priority and rank information.

2. The method of claim 1, further comprising providing, by a business metric store and dashboard module, a dashboard available via a wide area network, the dashboard providing business metric information about work order updates and revenue protected based upon the work order updates.

3. The method of claim 1, wherein the business customer sales information is received via a wide area network.

4. The method of claim 3, wherein the business customer sales information is received via a web application programming interface.

5. The method of claim 1, wherein the plurality of work orders are received via a wide area network.

6. The method of claim 1, wherein the machine learning model is a time-series module.

7. The method of claim 1, wherein the machine learning model is regularly updated upon receipt of additional business customer sales information.

8. The method of claim 1, wherein the priority is assigned to each received work order based on an equipment type and level of service required at each corresponding business location.

9. The method of claim 1, wherein the rank is also assigned based on a factor of peak sales hours for each corresponding business location.

10. The method of claim 1, wherein the rank is also assigned based on weighted average of factors including revenue, business day, peak sales hours, and location for each corresponding business location.

11. A system for providing dynamic incident management, comprising:
a processor; and
a hard disk including executable instructions in an allocated portion thereof, wherein the executable instructions when executed by the processor from the hard disk cause the processor to:
receive and store business customer sales information for each business customer sales location among a plurality of business customer sales locations, the business customer sales information including information about sales by day and time of day for a period of time at each business customer sales location;
generate a machine learning model for forecasting revenue for each business customer sales location based on the received business customer sales information;
receive and store a plurality of work orders for service calls to certain ones of the plurality of business customer sales locations, each work order for a corresponding one of the business customer sales locations;
assign a priority to each of the received work orders;
assign a rank to each of the received work orders having a common priority, the rank based on, at least in part, a revenue forecast provided the machine learning module of revenue at each corresponding business customer sales location at a projected day and time for the service call associated with the work orders; and
forward updated work orders having priority and rank information to an incident management supplier for arranging for the associated service calls to be performed in an order based on the priority and rank information.

12. The system of claim 11, wherein the executable instructions when executed by the processor from the hard disk cause the processor to provide a dashboard available via a wide area network, the dashboard providing business metric information about work order updates and revenue protected based upon the work order updates.

13. The system of claim 11, wherein the business customer sales information is received via a wide area network.

14. The system of claim 13, wherein the business customer sales information is received via a web application programming interface.

15. The system of claim 11, wherein the plurality of work orders are received via a wide area network.

16. The system of claim 11, wherein the machine learning model is a time-series module.

17. The system of claim 11, wherein the machine learning model is regularly updated upon receipt of additional business customer sales information.

18. The system of claim 11, wherein the priority is assigned to each received work order based on an equipment type and level of service required at each corresponding business location.

19. The system of claim 11, wherein the rank is also assigned based on a factor of peak sales hours for each corresponding business location.

20. The system of claim 11, wherein the rank is also assigned based on weighted average of factors including revenue, business day, peak sales hours, and location for each corresponding business location.
